(19) United States
(12) Patent Application Publication
(10) Pub. No.: US 2021/0141197 A1
(43) Pub. Date: May 13, 2021

(54) ZOOM LENS AND IMAGE PICKUP APPARATUS

(71) Applicant: CANON KABUSHIKI KAISHA, Tokyo (JP)

(72) Inventor: Yonghee Lee, Tochigi (JP)

(21) Appl. No.: 17/087,661

(22) Filed: Nov. 3, 2020

(30) Foreign Application Priority Data
Nov. 8, 2019 (JP) 2019-203094

(51) Int. Cl. G02B 15/14

(52) U.S. Cl. CPC G02B 15/144109; G02B 15/145125

(57) ABSTRACT

Provided is a zoom lens including, in order from an object side: a positive first lens unit configured not to move for zooming; a negative second lens unit configured to move in zooming; a negative third lens unit configured to move in zooming; and a positive lens unit configured not to move for zooming, wherein an interval between each pair of adjacent lens units is changed in zooming, wherein the positive first lens unit consists of, in order from the object side: a first lens sub unit configured not to move for focusing; and a second lens sub unit configured to move toward the object side for focusing from infinity to minimum object distance, the first lens sub unit including a negative lens arranged closest to the object side, and wherein an Abbe number of the negative lens and a partial dispersion ratio of the negative lens are appropriately set.

### BACKGROUND OF THE INVENTION

### Field of the Invention

The present invention relates to a zoom lens and an image pickup apparatus.

### Description of the Related Art

With increasing functionality of an image pickup apparatus (came using an image pickup element, it is required for a zoom lens used in the image pickup apparatus to have a high zoom ratio, a large aperture ratio, and high optical performance. In particular, a CCD, a CMOS, and other such image pickup devices used in professional-use television cameras or cinema cameras have high resolution that is highly uniform over an entire image pickup range. Therefore, it is required for the zoom lens to have high resolution that is highly uniform from the center to the periphery of an image and small chromatic aberration.

In Japanese Patent Application Laid-Open No. H07-151966, there is disclosed a zoom lens consisting of, in order from an object side to an image side, a first lens unit having a positive refractive power, a second lens unit having a negative refractive power, a third lens unit, and a fourth lens unit. Similarly, in Japanese Patent Application Laid-Open No. 2011-75646, there is disclosed a zoom lens consisting of, in order from an object side to an image side, a first lens unit having a positive refractive power, a second lens unit having a negative refractive power, a third lens unit having a negative refractive power, and a fourth lens unit having a positive refractive power. What is called a positive-lead type zoom lens, in which a first lens unit has a positive refractive power, can be advantageous in terms of a high zoom ratio as compared to what is called a negative-lead type zoom lens, in which a first lens unit has a negative refractive power.

In order to achieve the high zoom ratio, the large aperture ratio, a small size, a light weight, and the high optical performance, which are required of the zoom lens, it is important to correct chromatic aberration, in particular, to correct axial chromatic aberration and chromatic aberration of magnification on a telephoto side. When the number of lenses is reduced to achieve the small size and the light weight, refractive powers of lenses are increased, and various aberrations are increased. Further, in order to obtain the zoom lens having the high zoom ratio, it is difficult to sufficiently correct axial chromatic aberration and chromatic aberration of magnification on the telephoto side.

### SUMMARY OF THE INVENTION

An aspect of embodiments provides, for example, a zoom lens beneficial in a high zoom ratio, large aperture ratio, small size and weight, and high optical performance.

An aspect of embodiments provides a zoom lens including, in order from an object side to an image side: a first lens unit having a positive refractive power and configured not to move for zooming; a second lens unit having a negative refractive power and configured to move in zooming; a third lens unit having a negative refractive power and configured to move in zooming; and a lens unit having a positive refractive power and configured not to move for zooming, wherein an interval between each pair of adjacent lens units is changed in zooming, wherein the first lens unit consists of, in order from the object side to the image side: a first lens sub unit configured not to move for focusing; and a second lens sub unit configured to move toward the object side for focusing from infinity to a minimum object distance, the first lens sub unit including a lens Gln having a negative refractive power and arranged closest to the object side, and wherein following conditional expressions are satisfied:

24<νd<31; and

0.594<θgF<0.614,

where “νd” represents an Abbe number of the lens G1n, and θgF represents a partial dispersion ratio of the lens G1n. Here, the partial dispersion ratio θgF is expressed by a following expression:

θgF=(Ng−NF)/(NF−NC),

where Ng, NF, and NC represent refractive indices of a material with respect to a g-line (wavelength: 435.8 nm), an F-line (wavelength: 486.1 nm), and a C-line (wavelength: 656.3 nm), respectively.

Further features of the present invention will become apparent from the following description of exemplary embodiments with reference to attached drawings.

### BRIEF DESCRIPTION OF THE DRAWINGS

FIG. 1 is a lens cross-sectional view of a zoom lens according to Embodiment 1 when focus is at infinity at a wide angle end.

FIG. 2A shows aberration diagrams of the zoom lens according to Embodiment 1 when focus is at infinity at the wide angle end.

FIG. 2B shows aberration diagrams of the zoom lens according to Embodiment 1 when focus is at infinity at a telephoto end.

FIG. 3 is a lens cross-sectional view of a zoom lens according to Embodiment 2 when focus is at infinity at a wide angle end.

FIG. 4A shows aberration diagrams of the zoom lens according to Embodiment 2 when focus is at infinity at the wide angle end.

FIG. 4B shows aberration diagrams of the zoom lens according to Embodiment 2 when focus is at infinity at a telephoto end.

FIG. 5 is a lens cross-sectional view of a zoom lens according to Embodiment 3 when focus is at infinity at a wide angle end.

FIG. 6A shows aberration diagrams of the zoom lens according to Embodiment 3 when focus is at infinity at the wide angle end.

FIG. 6B shows aberration diagrams of the zoom lens according to Embodiment 3 when focus is at infinity at a telephoto end.

FIG. 7 is a lens cross-sectional view of a zoom lens according to Embodiment 4 when focus is at infinity at a wide angle end.

FIG. 8A shows aberration diagrams of the zoom lens according to Embodiment 4 when focus is at infinity at the wide angle end.

FIG. 8B shows aberration diagrams of the zoom lens according to Embodiment 4 when focus is at infinity at a telephoto end.

FIG. 9 is a schematic diagram of a main part of an image pickup apparatus according to the present invention.

### DESCRIPTION OF THE EMBODIMENTS

Now, exemplary embodiments of the present invention are described in detail with reference to the accompanying drawings.

A zoom lens according to each of Embodiments includes, in order from an object side to an image side: a first lens unit having a positive refractive power and configured not to move for zooming; a second lens unit having a negative refractive power and configured to move in zooming; a third lens unit having a negative refractive power and configured to move in zooming; and a lens unit having a positive refractive power and configured not to move for zooming. An interval between each pair of adjacent lens units is changed in zooming. The first lens unit includes, in order from the object side to the image side: a first lens sub unit configured not to move for focusing; and a second lens sub unit configured to move toward the object side for focusing from infinity to a minimum object distance. The first lens sub unit includes a lens G1n having a negative refractive power and arranged closest to the object side. The zoom lens satisfies the following conditional expressions:

24<νd<31; and

0.594<θgF<0.614,

where “νd” represents an Abbe number of the lens G1n, and θgF represents a partial dispersion ratio of the lens G1n.

Here, the Abbe number “νd” and the partial dispersion ratio θgF are expressed by the following expressions:

νd=(Nd−1)/(NF−NC); and

θgF=(Ng−NF)/(NF−NC),

where Ng, NF, NC, and Nd represent refractive indices of a material with respect to a g-line (wavelength: 435.8 nm), an F-line (wavelength: 486.1 nm), a. C-line (wavelength: 656.3 nm), and a d-line (wavelength: 587.6 nm), respectively.

In the zoom lens according to each of Embodiments 1 to 4, a first lens unit L1 is configured not to move for zooming. The zoom lens according to each of Embodiments is a positive-lead type zoom lens including a first lens unit having a positive refractive power, and a second lens unit having a negative refractive power and configured to move in zooming.

The first lens unit having the positive refractive power includes, in order from the object side to the image side: a first lens sub unit having a negative refractive power; and a second lens sub unit having a positive refractive power. The second lens sub unit is configured to move in an optical axis direction during focusing. With the above-mentioned configuration, a first lens unit having a compact and light-weight configuration can be obtained. The second lens sub unit may further consist of a third lens sub unit and a fourth lens sub unit, and the third lens sub unit and the fourth lens sub unit may be configured to move along different loci on an optical axis. With the second lens sub unit being divided into the two lens sub units configured to move along the different loci, an aberration variation caused by focusing can be suppressed.

With the first lens unit being configured not to move at all times for zooming, it becomes unnecessary to drive the entire first lens unit, which has a heavy weight, and a mechanism can be simplified. Further, it is possible to provide the effect that a total lens length is fixed during zooming. Still further, the second lens unit having the negative refractive power is configured to move toward the image side during zooming from a wide angle end to a telephoto end, and adopts a zoom type with which a high zoom ratio is easily achieved.

Features of the zoom lens according to the present invention are described by means of conditional expressions. The zoom lens according to the present invention has a high zoom ratio and a large aperture ratio, and in order to satisfactorily correct chromatic aberration on a telephoto side, in particular, includes a lens having a negative refractive power and arranged closest to the object side in the first lens unit. In the zoom lens, an Abbe number and a partial dispersion ratio of a material of the lens are appropriately defined.

The zoom lens according to the present invention includes, in order from an object side to an image side: a first lens unit having a positive refractive power and configured not to move for zooming; a second lens unit having a negative refractive power and configured to move in zooming; a third lens unit having a negative refractive power and configured to move in zooming; and a lens unit having a positive refractive power and configured not to move for zooming. The first lens unit includes, in order from the object side: a first lens sub unit configured not to move for focusing; and a second lens sub unit configured to move toward the object side for focusing from infinity to a minimum object distance. The first lens sub unit includes a lens G1n having a negative refractive power and arranged closest to the object side. The zoom lens satisfies the following conditional expressions:

24<νd<31 (1); and

0.594<θgF<0.614 (2),

where “νd” represents an Abbe number of the lens G1n, and θgF represents a partial dispersion ratio of the lens G1n.

Now, the Abbe number “νd” and the partial dispersion ratio θgF of the material of the optical element (lens) used in Embodiments are described. The Abbe number “νd” and the partial dispersion ratio θgF are expressed by the following expressions:

νd=(Nd−1)/(NF−NC); and

θgF=(Ng−NF)/(NF−NC),

where Ng, NF, NC, and Nd represent refractive indices of the material with respect to the g-line (wavelength: 435.8 nm), the F-line (486.1 nm), the C-line (656.3 nm), and the d-line (587.6 nm), respectively.

In the conditional expressions (1) and (2), the Abbe number and the partial dispersion ratio of the material of the lens G1n having the negative refractive power and arranged closest to the object side in the first lens sub unit, are defined; respectively. When the conditional expressions (1) and (2) are satisfied, chromatic aberration on the telephoto side can be corrected to an appropriate balance. When the lower limit value of the conditional expression (1) or the lower limit value of the conditional expression (2) is not satisfied, chromatic aberration cannot be appropriately corrected and not preferred. When the upper limit value of the conditional expression (1) or the upper limit value of the conditional expression (2) is not satisfied, a secondary spectrum of axial chromatic aberration on the telephoto side is disadvantageously increased.

It is preferred to set the numerical value ranges of the conditional expressions (1) and (2) as follows.

24<νd<29 (1a)

0.596<θgF<0.614 (2a)

Further, it is preferred to set the numerical value ranges of the conditional expressions (1a) and (2a) as follows.

24<νd<27 (1b)

0.598<θgF<0.614 (2b)

As a further aspect of the zoom lens according to the present invention, it is preferred to satisfy one or more of the following conditional expressions.

0.10<d/total_d1<0.20 (3)

0.000<|d/f1a|<0.030 (4)

0.9<f1b/f1<1.4 (5)

−1.8<f11/f1<−1.2 (6)

−0.01<(θpa−θna)/(νpa−νna)<0.01 (7)

0.00<1/(νpa−νna)<0.05 (8)

In the expressions, “d” represents an interval between the first lens sub unit and the second lens sub unit, total_d1 represents a distance from a surface closest to the object side to a surface closest to the image side in the first lens unit when focus is at infinity, f1a represents a focal length of the first lens sub unit, f1b represents a focal length of the second lens sub unit, f1 represents a focal length of the first lens unit, f11 represents a focal length of the lens Gln having the negative refractive power and arranged closest to the object side in the first lens sub unit, “νpa” represents an average Abbe number of positive lenses in the first lens unit, “νna” represents an average Abbe number of negative lenses in the first lens unit, “θpa” represents an average partial dispersion ratio of the positive lenses in the first lens unit, and “θna” represents an average partial dispersion ratio of the negative lenses in the first lens unit.

In the conditional expression (3), a ratio of the interval between the first lens sub unit and the second lens sub unit to the distance from the surface closest to the object side to the surface closest to the image side in the first lens sub unit when focus is at infinity is defined. When the conditional expression (3) is satisfied, the second lens sub unit, which is a focus lens unit, can be arranged at an appropriate position in the first lens unit. When the ratio exceeds the upper-limit condition of the conditional expression (3), the distance from the surface closest to the object side to the surface closest to the image side in the first lens unit becomes smaller, and hence curvature radii of the lenses become smaller, with the result that various aberrations become larger, or a movement amount of the second lens sub unit during focusing becomes larger, and a lens barrel structure becomes complicated. When the ratio falls below the lower-limit condition of the conditional expression (3), the distance from the surface closest to the object side to the surface closest to the image side in the first lens unit becomes larger, and the entire system of the zoom lens becomes larger, or the power of the second lens sub unit becomes larger, with the result that the aberration variation during focusing becomes disadvantageously larger.

In the conditional expression (4), a ratio of the interval between the first lens sub unit and the second lens sub unit to the focal length of the first lens sub unit is defined. When the conditional expression (4) is satisfied, an appropriate power can be imparted to the first lens sub unit. When the ratio exceeds the upper-limit condition of the conditional expression (4), the movement amount of the second lens sub unit becomes larger, and the lens barrel structure becomes complicated, or the power of the first lens sub unit becomes too strong, with the result that a large amount of various aberrations occurs, and optical performance is reduced. When the ratio falls below the lower-limit condition of the conditional expression (4), the power of the second lens sub unit becomes too strong, with the result that a large amount of various aberrations occurs, or the power of the first lens sub unit becomes too weak, which is not preferred.

In the conditional expression (5), a ratio of the focal length of the second lens sub unit to the focal length of the first lens unit is defined. When the conditional expression (5) is satisfied, the power of the second lens sub unit can be appropriately set. When the ratio exceeds the upper-limit condition of the conditional expression (5), the power of the second lens sub unit becomes weaker, and the movement amount during focusing is disadvantageously increased. When the ratio falls below the lower-limit condition of the conditional expression (5), the power of the second lens sub unit becomes too strong, and the aberration variation during focusing is disadvantageously increased.

In the conditional expression (6), a ratio of the focal length of the negative lens G1n to the focal length of the first lens unit is defined. When the conditional expression (6) is satisfied, the power of the negative lens G1n can be appropriately set, and a secondary spectrum of chromatic aberration on the telephoto side can be satisfactorily corrected. When the ratio exceeds the upper-limit condition of the conditional expression (6), the power of the negative lens G1n becomes too weak, and chromatic aberration on the telephoto side cannot be sufficiently corrected. When the ratio falls below the lower-limit condition of the conditional expression (6), the power of the negative lens G1n becomes excessively strong, and a large amount of various aberrations disadvantageously occurs.

in the conditional expression (7), a balance of correcting chromatic aberration between the positive lenses and the negative lenses in the first lens unit is defined. When the conditional expression (7) is satisfied, an appropriate chromatic aberration balance in the first lens unit can be achieved. When the balance exceeds the upper-limit condition of the conditional expression (7), chromatic aberration in the first lens unit is undercorrected. When the balance falls below the lower-limit condition of the conditional expression (7), chromatic aberration in the first lens unit is disadvantageously overcorrected.

In the conditional expression (8), a difference in Abbe number between the positive lenses and the negative lenses in the first lens unit is defined. When the conditional expression (8) is satisfied, an aberration balance of the first lens unit can be appropriately set. When the difference exceeds the upper-limit condition of the conditional expression (8), powers of the lenses become stronger, and various aberrations become more likely to occur, which is not preferred. When the difference falls below the lower-limit condition of the conditional expression (8), it becomes difficult to select the material.

It is preferred to set the numerical value ranges of the conditional expressions (4) to (8) as follows.

0.11<d/total_d1<0.19 (3a)

0.005<|d/f1a|<0.025 (4a)

0.95<f1b/1<1.00 (5a)

−1.6<f11/f1<−1.5 (6a)

−0.01<(θpa−θna)/(νpa−νna)<0.01 (7a)

0<1/(νpa−νna)<0.05 (8a)

Further, it is more preferred to set the numerical value ranges of the conditional expressions (4a) to (8a) as follows.

0.12<d/total_d1<0.19 (3b)

0.016<|d/f1a|<−0.010 (4b)

0.95<f1b/f1<1.00 (5b)

−1.6<f11/f1<−1.5 (6b)

−0.01<(θpa−θna)/(νpa−νna)<0.01 (7b)

0<1/(νpa−νna)<0.05 (8b)

Further, as a further aspect of the zoom lens according to the present invention, the first lens unit includes a lens having a positive refractive power that satisfies the following conditional expressions:

80<νd<85 (9); and

0.534<θgF<0.540 (10),

where “νd” represents an Abbe number of the lens, and θgF represents a partial dispersion ratio of the lens.

When a material satisfying the conditional expressions (9) and (10) is used for the lens having the positive refractive power in the first lens unit, chromatic aberration on the telephoto side can be corrected more.

Further, as a further aspect of the zoom lens according to the present invention, the first lens unit includes a lens having a positive refractive power that satisfies the following conditional expressions:

65<νd<70 (11); and

0.540<θgF<0.548 (12).

When a material satisfying the conditional expressions (11) and (12) is used for the lens having the positive refractive power in the first lens unit, chromatic aberration on the telephoto side can be corrected more.

As a further aspect of the zoom lens according to the present invention, the first lens sub unit consists of, from an end closest to the object side, the following two lenses: a lens having a negative refractive power: and a lens having a positive refractive power. With the first lens sub unit consisting of the two lenses, design flexibility is increased, and variations in various aberrations are reduced so that the variations can be controlled in a balanced manner.

As a further aspect of the zoom lens according to the present invention, the second lens sub unit consists of, from an end closest to the object side, the following two lenses: a lens having a positive refractive power; and a lens having a positive refractive power. With this configuration, remaining aberration in the first lens sub unit is canceled, and the aberrations can be satisfactorily corrected.

With the above-mentioned configuration of the elements, the zoom lens having a wide angle of view, the high zoom ratio, the large aperture ratio, and high optical performance over the entire zoom range, with which chromatic aberration on the telephoto side in particular is satisfactorily corrected, can be obtained.

### Embodiment 1

FIG. 1 is a lens cross-sectional view of Embodiment 1 at a wide angle end. Embodiment 1 relates to a zoom lens having a zoom ratio of 17× and an aperture ratio of about 2. In the lens cross-sectional view, the left side is the object side (front side), and the right side is the image side (back side). When “i” represents the order of a lens unit from the object side, Li represents the i-th lens unit. An optical block, such as a prism or an optical filter, is denoted by G. An aperture stop is denoted by SP. An image plane is denoted by IP. When the zoom lens is used as an image pickup optical system of a digital camera, a video camera, or a monitoring camera, the image plane IP corresponds to an image pickup surface of an image pickup element (photoelectric conversion element), such as a CCD sensor or a CMOS sensor. The same applies to Embodiments to be described later.

The zoom lens according to Embodiment 1 consists of, in order from the object side to the image side, the following four lens units: a first lens unit L1 having a positive refractive power; a second lens unit L2 having a negative refractive power; a third lens unit L3 having a negative refractive power; an aperture stop SP; and a fourth lens unit L4 having a positive refractive power. The first lens unit L1, the aperture stop SP, and the fourth lens unit L4 are configured not to move for zooming. During zooming from the wide angle end to the telephoto end, the second lens unit L2 is configured to move toward the image side, and the third lens unit L3 is configured to move along a locus that is convex toward the object side. Further, during zooming from the wide angle end to the telephoto end, the aperture stop and a part or all of the fourth lens unit may be configured to move integrally.

The first lens unit L1 consists of, in order from the object side to the image side: a first lens sub unit Lia having a negative refractive power and configured not to move for focusing; and a second lens sub unit Lib having a positive refractive power and configured to move on the optical axis during focusing. An inner focusing system in which, when focusing is performed, the second lens sub unit L1b of the first lens unit L1 is moved on the optical axis for focusing is adopted. When focusing is performed from infinity to close distance; the second lens sub unit L1b is configured to move on the optical axis toward the object side.

FIG. 2A and FIG. 2B show aberration diagrams of Embodiment 1 when focus is at infinity at the wide angle end and the telephoto end, respectively. In the aberration diagrams, the solid line indicates the d-line, the two-dot chain line indicates the g-line, the one-dot chain line indicates the C-line, and the broken line indicates the F-line in spherical aberration, chromatic aberration of magnification, and distortion. The broken line and the solid line in the astigmatism diagram indicate a meridional image plane and a sagittal image plane, respectively. A half angle of view is represented by “ω,” and an f number is represented by Fno. The spherical aberration diagram, the astigmatism diagram, the distortion diagram, and the chromatic-aberration-of-magnification diagram are drawn on the scales of 0.4 mm, 0.4 mm, 5%, and 0.05 mm, respectively. The same applies to Embodiments to be described belo.

### Embodiment 2

FIG. 3 is a lens cross-sectional view of Embodiment 2 at a wide angle end. Embodiment 2 relates to a zoom lens having a zoom ratio of 17× and an aperture ratio of about 2.

A schematic configuration and movements in zooming and focusing of lens units of the zoom lens according to Embodiment 2 are similar to those in Embodiment 1, and hence description thereof is omitted.

FIG. 4A and FIG. 4B show aberration diagrams of Embodiment 2 when focus is at infinity at the wide angle end and the telephoto end, respectively.

### Embodiment 3

FIG. 5 is a lens cross-sectional view of Embodiment 3 at a wide angle end. Embodiment 3 relates to a zoom lens having a zoom ratio of 17× and an aperture ratio of about 2.

A schematic configuration and movements in zooming and focusing of lens units of the zoom lens according to Embodiment 3 are similar to those in Embodiment 1, and hence description thereof is omitted.

FIG. 6A and FIG. 6B show aberration diagrams of Embodiment 3 when focus is at infinity at the wide angle end and the telephoto end, respectively.

### Embodiment 41

FIG. 7 is a lens cross-sectional view of Embodiment 4 at a wide angle end. Embodiment 4 relates to a zoom lens having a zoom ratio of 17.33× and an aperture ratio of about 1.82 to 2.54.

The zoom lens according to Embodiment 4 consists of, in order from the object side to the image side, the following five lens units: a first lens unit L1 having a positive refractive power; a second lens unit L2 having a negative refractive power; a third lens unit L3 having a negative refractive power; a fourth lens unit L4 having a positive refractive power; an aperture stop SP; and a fifth lens unit L5 having a positive refractive power. The first lens unit L1, the aperture stop SP, and the fifth lens unit L5 are configured not to move for zooming. During zooming from the wide angle end to the telephoto end, the second lens unit L2 is configured to move toward the image side, the third lens unit L3 is configured to move along a locus that is convex toward the object side, and the fourth lens unit L4 is configured to move along a locus that is convex toward the object side. Further, during zooming from the wide angle end to the telephoto end, the aperture stop and a part or all of the fourth lens unit may be configured to move integrally.

The first lens unit L1 consists of, in order from the object side to the image side: a first lens sub unit Lia having a negative refractive power and configured not to move for focusing; and a second lens sub unit L1b having a positive refractive power and configured to move on the optical axis during focusing. An inner focusing system in which, when focusing is performed, the second lens sub unit L1b of the first lens unit L1 is moved on the optical axis for focusing is adopted. When focusing is performed from infinity to close distance, the second lens sub unit L1b is configured to move on the optical axis toward the object side.

FIG. 8A and FIG. 8B show aberration diagrams of Embodiment 4 when focus is at infinity at the wide angle end and the telephoto end, respectively.

Next, with reference to FIG. 9, an embodiment of a television camera (image pickup apparatus) using the zoom lens according to the present invention as an image pickup optical system is described. A zoom lens 101 that is the zoom lens according to any one of Embodiments 1 to 4 is illustrated in FIG. 9. A camera 124 is illustrated in FIG. 9. The zoom lens 101 may be detachably mounted on the camera 124, to thereby form an image pickup apparatus 125. The zoom lens 101 includes a first lens unit F, a zoom portion LZ, and lens units R for imaging. The first lens unit F includes a lens unit configured to move for focusing.

The zoom portion LZ includes at least two or more lens units configured to move in zooming. On the image side of the zoom portion LZ, an aperture stop SP, a lens unit R1, a lens unit R2, and a lens unit R3 are arranged, and the image pickup apparatus includes a lens unit IF, which can be inserted into and removed from an optical path. The lens unit IE is inserted into a space between the lens unit R1 and the lens unit R3 so that the focal length range of the entire system of the zoom lens 101 can be changed.

Drive mechanisms 114 and 115, such as a helicoid or a cam, are configured to drive the first lens unit F and the zoom portion LZ in an optical axis direction, respectively. Motors (drive units) 116 to 118 are configured to electrically drive the drive mechanism 114, the drive mechanism 115, and the aperture stop SP, respectively.

Detectors 119 to 121, such as an encoder, a potentiometer, or a photo-sensor, are configured to detect positions of the first lens unit F and the zoom portion LZ on the optical axis, and an aperture diameter of the aperture stop SP. The camera 124 includes a glass block 109, which corresponds to an optical filter or a color separation optical system provided within the camera 124. An image pickup element (photoelectric transducer) 110, such as a charge-coupled device (CCD) sensor or a complementary metal-oxide semiconductor (CMOS) sensor, is configured to receive an object image formed by the zoom lens 101. Further, central processing units (CPUs: control units) 111 and 122 are configured to control the driving of the camera 124 and the zoom lens 101 in various manners.

Through the application of the zoom lens according to the present invention to the television camera as described above, the image pickup apparatus having the high optical performance is achieved.

Next, Numerical Embodiments 1 to 4 corresponding to Embodiments 1 to 4 of the present invention, respectively, are described. In each of Numerical Embodiments, the order of a surface from the object side is represented by “i.” A curvature radius of the i-th lens surface in order from the object side is represented by “ri,” a lens thickness or air interval between the i-th surface and the (i+1)th surface in order from the object side is represented by “di,” and a refractive index and an Abbe number of a material of a lens between the i-th surface and the (i+1)th surface in order from the object side are represented by “ndi” and “νdi,” respectively. A back focus BF is expressed by an air-equivalent distance from the last lens surface to the image plane. The total lens length is a value obtained by adding the back focus to a distance from the first surface to the last surface.

Results of calculating the conditional expressions based on lens data of Numerical Embodiments 1 to 4 to be provided below are shown in Table 1.

The exemplary embodiments of the present invention are described above, but the present invention is not limited to those embodiments and can be modified and changed variously within the scope of the gist thereof.

(Numerical Embodiment 1)
Unit: mm
Surface data

| Surface number | r | d | nd | νd |
|---|---|---|---|---|
| 1 | −1,952.696 | 2.20 | 1.85478 | 24.8 |
| 2 | 112.674 | 6.84 | | |
| 3 | 142.326 | 11.66 | 1.48749 | 70.2 |
| 4 | −195.338 | 7.29 | | |
| 5 | 127.293 | 9.00 | 1.59522 | 67.7 |
| 6 | −249.729 | 0.15 | | |
| 7 | 56.938 | 6.09 | 1.72916 | 54.7 |
| 8 | 116.854 | (Variable) | | |
| 9 | 181.140 | 0.75 | 1.88300 | 40.8 |
| 10 | 15.297 | 4.97 | | |
| 11 | −126.442 | 5.34 | 1.80810 | 22.8 |
| 12 | −15.029 | 0.70 | 1.88300 | 40.8 |
| 13 | 71.177 | 0.14 | | |
| 14 | 25.438 | 3.12 | 1.69895 | 30.1 |
| 15 | 56.384 | (Variable) | | |
| 16 | −30.120 | 1.70 | 1.80610 | 40.9 |
| 17 | 35.770 | 3.25 | 1.84666 | 23.8 |
| 18 | −12,749.406 | (Variable) | | |
| 19 (Stop) | ∞ | 3.03 | | |
| 20 | 9,109.103 | 4.86 | 1.62041 | 60.3 |
| 21 | −38.624 | 0.15 | | |
| 22 | 65.278 | 7.96 | 1.48749 | 70.2 |
| 23 | −27.258 | 2.50 | 1.88300 | 40.8 |
| 24 | −52.567 | 36.50 | | |
| 25 | −93.562 | 5.38 | 1.62588 | 35.7 |
| 26 | −35.598 | 3.00 | | |
| 27 | 62.016 | 6.00 | 1.51742 | 52.4 |
| 28 | −41.936 | 1.20 | 1.88300 | 40.8 |
| 29 | −2,786.886 | 0.15 | | |
| 30 | 66.810 | 7.13 | 1.49700 | 81.5 |
| 31 | −22.258 | 1.20 | 1.88300 | 40.8 |
| 32 | 75.522 | 0.31 | | |
| 33 | 40.185 | 6.96 | 1.49700 | 81.5 |
| 34 | −32.403 | 4.00 | | |
| 35 | ∞ | 33.00 | 1.60859 | 46.4 |
| 36 | ∞ | 13.20 | 1.51680 | 64.2 |
| 37 | ∞ | 6.80 | | |
| Image plane | ∞ | | | |

Various data
Zoom ratio 17.00

| | Wide angle | Intermediate | Telephoto |
|---|---|---|---|
| Focal length | 8.50 | 36.81 | 144.50 |
| F-number | 2.00 | 2.00 | 2.45 |
| Half angle of view | 32.91 | 8.50 | 2.18 |
| Image height | 5.50 | 5.50 | 5.50 |
| Total lens length | 269.84 | 269.84 | 269.84 |
| BF | 6.80 | 6.80 | 6.80 |
| d8 | 0.58 | 39.35 | 54.95 |
| d15 | 57.40 | 13.91 | 5.68 |
| d18 | 5.35 | 10.07 | 2.70 |
| d37 | 6.80 | 6.80 | 6.80 |

Zoom lens unit data

| Unit | First surface | Focal length |
|---|---|---|
| 1 | 1 | 73.45 |
| 2 | 9 | −15.40 |
| 3 | 16 | −39.10 |
| 4 | 19 | 51.54 |

(Numerical Embodiment 2)
Unit: mm
Surface data

| Surface number | r | d | nd | νd |
|---|---|---|---|---|
| 1 | −761.889 | 2.20 | 1.85478 | 24.8 |
| 2 | 112.273 | 6.09 | | |
| 3 | 142.326 | 11.66 | 1.49700 | 81.5 |
| 4 | −195.338 | 7.29 | | |
| 5 | 144.316 | 9.00 | 1.59522 | 67.7 |
| 6 | −222.812 | 0.15 | | |
| 7 | 59.305 | 6.61 | 1.76385 | 48.5 |
| 8 | 136.141 | (Variable) | | |
| 9 | 181.140 | 0.75 | 1.88300 | 40.8 |
| 10 | 15.297 | 4.97 | | |
| 11 | −126.442 | 5.34 | 1.80810 | 22.8 |
| 12 | −15.029 | 0.70 | 1.88300 | 40.8 |
| 13 | 71.177 | 0.14 | | |
| 14 | 25.438 | 3.12 | 1.69895 | 30.1 |
| 15 | 56.294 | (Variable) | | |
| 16 | −30.120 | 1.70 | 1.80610 | 40.9 |
| 17 | 35.770 | 3.25 | 1.84666 | 23.8 |
| 18 | −39,831.046 | (Variable) | | |
| 19 (Stop) | ∞ | 3.03 | | |
| 20 | −333.675 | 4.70 | 1.62041 | 60.3 |
| 21 | −32.002 | 0.21 | | |
| 22 | 79.106 | 8.07 | 1.48749 | 70.2 |
| 23 | −25.359 | 2.50 | 1.88300 | 40.8 |
| 24 | −49.834 | 36.50 | | |
| 25 | −74.870 | 5.34 | 1.62588 | 35.7 |
| 26 | −33.703 | 3.00 | | |
| 27 | 126.088 | 6.52 | 1.51742 | 52.4 |
| 28 | −41.462 | 1.20 | 1.88300 | 40.8 |
| 29 | −119.177 | 0.15 | | |
| 30 | 66.313 | 7.20 | 1.49700 | 81.5 |
| 31 | −23.087 | 1.20 | 1.88300 | 40.8 |
| 32 | 60.154 | 0.44 | | |
| 33 | 38.105 | 8.49 | 1.49700 | 81.5 |
| 34 | −33.392 | 4.00 | | |
| 35 | ∞ | 33.00 | 1.60859 | 46.4 |
| 36 | ∞ | 13.20 | 1.51680 | 64.2 |
| 37 | ∞ | 6.80 | | |
| Image plane | ∞ | | | |

Various data
Zoom ratio 17.00

| | Wide angle | Intermediate | Telephoto |
|---|---|---|---|
| Focal length | 8.50 | 36.80 | 144.50 |
| F-number | 2.00 | 2.00 | 2.43 |
| Half angle of view | 32.91 | 8.50 | 2.18 |
| Image height | 5.50 | 5.50 | 5.50 |
| Total lens length | 272.60 | 272.60 | 272.60 |
| BF | 6.80 | 6.80 | 6.80 |
| d8 | 1.35 | 40.12 | 55.72 |
| d15 | 57.42 | 13.93 | 5.69 |
| d18 | 5.35 | 10.07 | 2.70 |
| d37 | 6.80 | 6.80 | 6.80 |

Zoom lens unit data

| Unit | First surface | Focal length |
|---|---|---|
| 1 | 1 | 73.45 |
| 2 | 9 | −15.40 |
| 3 | 16 | −39.10 |
| 4 | 19 | 53.97 |

(Numerical Embodiment 3)
Unit: mm
Surface data

| Surface number | r | d | nd | νd |
|---|---|---|---|---|
| 1 | −593.436 | 2.20 | 1.85025 | 30.1 |
| 2 | 92.996 | 2.59 | | |
| 3 | 96.632 | 8.75 | 1.49700 | 81.5 |
| 4 | −20,365.009 | 0.20 | | |
| 5 | 3,056.510 | 6.88 | 1.43387 | 95.1 |
| 6 | −135.833 | 7.21 | | |
| 7 | 151.713 | 9.00 | 1.59522 | 67.7 |
| 8 | −189.601 | 0.10 | | |
| 9 | 53.462 | 6.00 | 1.77250 | 49.6 |
| 10 | 96.520 | (Variable) | | |
| 11 | 181.140 | 0.75 | 1.88300 | 40.8 |
| 12 | 15.297 | 4.97 | | |
| 13 | −126.442 | 5.34 | 1.80810 | 22.8 |
| 14 | −15.029 | 0.70 | 1.88300 | 40.8 |
| 15 | 71.177 | 0.14 | | |
| 16 | 25.438 | 3.12 | 1.69895 | 30.1 |
| 17 | 56.294 | (Variable) | | |
| 18 | −30.120 | 1.70 | 1.80610 | 40.9 |
| 19 | 35.770 | 3.25 | 1.84666 | 23.8 |
| 20 | −39,831.046 | (Variable) | | |
| 21(Stop) | ∞ | 3.03 | | |
| 22 | 163.735 | 5.05 | 1.62041 | 60.3 |
| 23 | −48.599 | 0.17 | | |
| 24 | 64.701 | 7.75 | 1.48749 | 70.2 |
| 25 | −26.799 | 2.50 | 1.88300 | 40.8 |
| 26 | −51.740 | 36.50 | | |
| 27 | −52.797 | 3.73 | 1.62588 | 35.7 |
| 28 | −32.343 | 1.50 | | |
| 29 | 29.374 | 8.66 | 1.51742 | 52.4 |
| 30 | −38.566 | 1.20 | 1.88300 | 40.8 |
| 31 | 23.590 | 0.15 | | |
| 32 | 22.810 | 6.93 | 1.49700 | 81.5 |
| 33 | −40.435 | 1.20 | 1.88300 | 40.8 |
| 34 | −77.598 | 0.15 | | |
| 35 | 32.343 | 3.95 | 1.49700 | 81.5 |
| 36 | 229.778 | 4.00 | | |
| 37 | ∞ | 33.00 | 1.60859 | 46.4 |
| 38 | ∞ | 13.20 | 1.51680 | 64.2 |
| 39 | ∞ | 6.80 | | |
| Image plane | ∞ | | | |

Various data
Zoom ratio 17.00

| | Wide angle | Intermediate | Telephoto |
|---|---|---|---|
| Focal length | 8.50 | 36.80 | 144.50 |
| F-number | 2.00 | 2.00 | 2.46 |
| Half angle of view | 32.91 | 8.50 | 2.18 |
| Image height | 5.50 | 5.50 | 5.50 |
| Total lens length | 265.32 | 265.32 | 265.32 |
| BF | 6.80 | 6.80 | 6.80 |
| d10 | 0.20 | 38.97 | 54.58 |
| d17 | 57.42 | 13.93 | 5.69 |
| d20 | 5.35 | 10.07 | 2.70 |
| d39 | 6.80 | 6.80 | 6.80 |

Zoom lens unit data

| Unit | First surface | Focal length |
|---|---|---|
| 1 | 1 | 73.45 |
| 2 | 11 | −15.40 |
| 3 | 18 | −39.10 |
| 4 | 21 | 47.75 |

(Numerical Embodiment 4)
Unit: mm
Surface data

| Surface number | r | d | nd | νd |
|---|---|---|---|---|
| 1 | −130.278 | 2.30 | 1.85478 | 24.8 |
| 2 | 243.248 | 13.17 | | |
| 3 | −1,297.049 | 8.13 | 1.49700 | 81.5 |
| 4 | −94.853 | 0.10 | | |
| 5 | 255.395 | 8.38 | 1.48749 | 70.2 |
| 6 | −149.045 | 6.91 | | |
| 7 | 76.056 | 10.92 | 1.53775 | 74.7 |
| 8 | 521.193 | 0.10 | | |
| 9 | 61.360 | 5.00 | 1.76385 | 48.5 |
| 10 | 117.707 | (Variable) | | |
| 11 | 61.770 | 0.95 | 1.88300 | 40.8 |
| 12 | 14.199 | 6.15 | | |
| 13 | −57.034 | 6.90 | 1.80810 | 22.8 |
| 14 | −13.573 | 0.74 | 1.88300 | 40.8 |
| 15 | 54.014 | 0.21 | | |
| 16 | 28.253 | 2.90 | 1.66680 | 33.0 |
| 17 | 138.727 | (Variable) | | |
| 18 | −27.096 | 0.70 | 1.75700 | 47.8 |
| 19 | 35.476 | 2.87 | 1.84649 | 23.9 |
| 20 | 1,838.082 | (Variable) | | |
| 21 | −146.751 | 3.66 | 1.63854 | 55.4 |
| 22 | −30.071 | 0.15 | | |
| 23 | 73.122 | 3.70 | 1.51633 | 64.1 |
| 24 | −82.210 | (Variable) | | |
| 25 (Stop) | ∞ | 1.30 | | |
| 26 | 56.215 | 5.92 | 1.59410 | 60.5 |
| 27 | −30.077 | 0.90 | 1.83481 | 42.7 |
| 28 | 217.524 | 32.40 | | |
| 29 | −120.477 | 4.61 | 1.49700 | 81.5 |
| 30 | −34.058 | 0.30 | | |
| 31 | −395.614 | 1.40 | 1.83403 | 37.2 |
| 32 | 20.109 | 5.38 | 1.48749 | 70.2 |
| 33 | 162.715 | 0.29 | | |
| 34 | 75.117 | 6.50 | 1.50127 | 56.5 |
| 35 | −20.205 | 1.40 | 1.83481 | 42.7 |
| 36 | −45.295 | 2.04 | | |
| 37 | 48.450 | 5.30 | 1.50127 | 56.5 |
| 38 | −36.982 | 4.00 | | |
| 39 | ∞ | 33.00 | 1.60859 | 46.4 |
| 40 | ∞ | 13.20 | 1.51633 | 64.1 |
| 41 | ∞ | 7.52 | | |
| Image plane | ∞ | | | |

Various data
Zoom ratio 17.33

| | Wide angle | Intermediate | Telephoto |
|---|---|---|---|
| Focal length | 8.00 | 33.39 | 138.63 |
| F-number | 1.82 | 1.82 | 2.54 |
| Half angle of view | 34.51 | 9.35 | 2.27 |
| Image height | 5.50 | 5.50 | 5.50 |
| Total lens length | 269.79 | 269.79 | 269.79 |
| BF | 7.52 | 7.52 | 7.52 |
| d10 | 0.10 | 32.22 | 46.32 |
| d17 | 48.33 | 9.47 | 11.40 |
| d20 | 6.22 | 10.79 | 0.50 |
| d24 | 5.74 | 7.91 | 2.17 |
| d41 | 7.52 | 7.52 | 7.52 |

Zoom lens unit data

| Unit | First surface | Focal length |
|---|---|---|
| 1 | 1 | 61.00 |
| 2 | 11 | −14.20 |
| 3 | 18 | −38.65 |
| 4 | 21 | 33.16 |
| 5 | 25 | 45.28 |

TABLE 1

| | | Embodi- | Embodi- | Embodi- | Embodi- |
|---|---|---|---|---|---|
| Conditional Expression | | ment 1 | ment 2 | ment 3 | ment 4 |
| (1) | νd | 24.80 | 24.80 | 30.05 | 24.80 |
| (2) | θgF | 0.612 | 0.612 | 0.598 | 0.612 |
| (3) | d/total_d1 | 0.169 | 0.170 | 0.168 | 0.126 |
| (4) | \|d/f1a\| | 0.013 | 0.017 | 0.012 | 0.014 |
| (5) | f1b/f1 | 0.982 | 0.957 | 0.982 | 1.357 |
| (6) | f11/f1 | −1.680 | −1.557 | −1.285 | −1.622 |
| (7) | (θpa − θna)/ | −0.002 | −0.002 | −0.001 | −0.002 |
| | (νpa − νna) | | | | |
| (8) | 1/(νpa − νna) | 0.025 | 0.024 | 0.023 | 0.024 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-203094, filed Nov. 8, 2019, which is hereby incorporated by reference herein in its entirety.

What is claimed is:

1. A zoom lens comprising in order from an object side to an image side:
a first lens unit having a positive refractive power and configured not to move for zooming;
a second lens unit having a negative refractive power and configured to move in zooming;
a third lens unit having a negative refractive power and configured to move in zooming; and
a lens unit having a positive refractive power and configured not to move for zooming,
wherein an interval between each pair of adjacent lens units is changed in zooming,
wherein the first lens unit consists of in order from the object side to the image side:
a first lens sub unit configured not to move for focusing; and
a second lens sub unit configured to move toward the object side for focusing from infinity to a minimum object distance,
the first lens sub unit including a lens G1n having a negative refractive power and arranged closest to the object side, and
wherein following conditional expressions are satisfied:
24<νd<31; and
0.594<θgF<0.614,
where νd represents an Abbe number of the lens G1n, and θgF represents a partial dispersion ratio of the lens G1n, and the partial dispersion ratio θgF is expressed by a following expression:
θgF=(Ng−NF)/(NF−NC),
where Ng, NF and NC represent refractive indices of a material with respect to a g-line (wavelength: 435.8 nm), an F-line (wavelength: 486.1 nm), a C-line (wavelength: 656.3 nm), respectively.

2. The zoom lens according to claim 1, wherein a following conditional expression is satisfied:
0.10<d/total_d1<0.20,
where d represents an interval between the first lens sub unit and the second lens sub unit, and total_d1 represents a distance on an optical axis from a surface closest to the object side in the first lens unit to a surface closest to the image side in the first lens unit.

3. The zoom lens according to claim 1, wherein a following conditional expression is satisfied:
0.000<|d/f1a|<0.030,
where d represents an interval between the first lens sub unit and the second lens sub unit, and f1a represents a focal length of the first lens sub unit.

4. The zoom lens according to claim 1, wherein a following conditional expression is satisfied:
0.9<f1b/f1<1.4,
where f1b represents a focal length of the second lens sub unit, and f1 represents a focal length of the first lens unit.

5. The zoom lens according to claim 1, wherein a following conditional expression is satisfied:
−1.8<f11/f1<−1.2,
where f1 represents a focal length of the first lens unit, and f11 represents a focal length of the lens G1n.

6. The zoom lens according to claim 1, wherein following conditional expressions are satisfied:
−0.01<(θpa−θna)/(νpa−νna)<0.01; and
0.00<1/(νpa−νna)<0.05,
where νpa represents an average Abbe number of positive lenses included in the first lens unit, θpa represents an average partial dispersion ratio of the positive lenses included in the first lens unit, νna represents an average Abbe number of negative lenses included in the first lens unit, and θna represents an average partial dispersion ratio of the negative lenses included in the first lens unit.

7. The zoom lens according to claim 1, wherein the first lens unit includes a positive lens that satisfies following conditional expressions:
80<νd<85; and
0.534<θgF<0.5410,
where νd represents an Abbe number of the positive lens, and θgF represents a partial dispersion ratio of the positive lens.

8. The zoom lens according to claim 1, wherein the first lens unit includes a positive lens that satisfies following conditional expressions:
65<νd<70; and
0.540<θgF<0.548,
where νd represents an Abbe number of the positive lens, and θgF represents a partial dispersion ratio of the positive lens.

9. The zoom lens according to claim 1, wherein the first lens sub unit consists of, in order from the object side to the image side, a lens having a negative refractive power, and a lens having a positive refractive power.

10. The zoom lens according to claim 1, wherein the second lens sub unit consists of, in order from the object side to the image side, a lens having a positive refractive power, and a lens having a positive refractive power.

11. An image pickup apparatus comprising:
a zoom lens comprising in order from an object side to an image side:
a first lens unit having a positive refractive power and configured not to move for zooming;
a second lens unit having a negative refractive power and configured to move in zooming;
a third lens unit having a negative refractive power and configured to move in zooming; and
a lens unit having a positive refractive power and configured not to move for zooming,
wherein an interval between each pair of adjacent lens units is changed in zooming,
wherein the first lens unit consists of in order from the object side to the image side:
a first lens sub unit configured not to move for focusing; and
a second lens sub unit configured to move toward the object side for focusing from infinity to a minimum object distance,
the first lens sub unit including a lens G1n having a negative refractive power and arranged closest to the object side, and
wherein following conditional expressions are satisfied:
24<νd<31; and
0.594<θgF<0.614,
where νd represents an Abbe number of the lens G1n, and θgF represents a partial dispersion ratio of the lens G1n, and the partial dispersion ratio θgF is expressed by a following expression:
θgF=(Ng−NF)/(NF−NC),
where Ng, NF, and NC represent refractive indices of materials with respect to a g-line (wavelength: 435.8 nm), an F-line (wavelength: 486.1 nm), and a C-line (wavelength: 656.3 nm), respectively; and
an image pickup element configured to pick up an image formed by the zoom lens.
